(19) United States
(12) Patent Application Publication
(10) Pub. No.: US 2016/0039701 A1
(43) Pub. Date: Feb. 11, 2016

(54) Method and Installation for Thermal Digestion of Biomass

(71) Applicant: Sustec Consulting & Contracting B.V., Wageningen (NL)

(72) Inventor: Alex Hol, Beuningen (NL)

(21) Appl. No.: 14/885,307

(22) Filed: Oct. 16, 2015

Related U.S. Application Data
(63) Continuation of application No. PCT/NL2014/050253, filed on Apr. 18, 2014.

(30) Foreign Application Priority Data
Apr. 19, 2013 (NL) 2010676

(51) Int. Cl. C02F 11/18

(52) U.S. Cl. CPC C02F 11/18; C02F 2201/00

(57) ABSTRACT

The invention relates to a method for thermal digestion of pumpable biomass, like sewage sludge. The method comprises the steps of supplying fresh biomass, preheating the supplied fresh biomass, hydrolysing the preheated biomass, cooling the hydrolysed biomass and discharging the cooled biomass.

The supplied biomass is preheated here in at least two steps, wherein in one of the steps at least apart of the supplied biomass is mixed with at least a part of the hydrolysed biomass, and wherein in another step at least a part of the supplied biomass is brought into head-exchanging contact with a prewarming or preheating medium. At least 25 percent, more preferably at least 75 percent and most preferably substantially 100 percent of the hydrolysed biomass may be mixed with the supplied fresh biomass.

The mixture formed during the preheating can optionally be separated again into preheated, fresh biomass and partially cooled, hydrolysed biomass.

The invention further relates to an installation for performing this method.

The invention relates to a method for thermal digestion of pumpable biomass, comprising the steps of supplying fresh biomass, preheating the supplied fresh biomass, hydrolysing the preheated biomass, cooling the hydrolysed biomass and discharging the cooled biomass. Such a method is already known in different variants.

“Pumpable biomass” is understood in this application to mean in particular sewage sludge, a paste-like material, although other biodegradable materials having similar consistency and viscosity are conceivable.

Applicant already markets under the name TurboTec® an installation in which biomass, particularly sludge from the purification of waste water, can be hydrolysed in a continuous process. The installation consists of a reactor, a steam supply and a number of heat exchangers. Fresh biomass, which can for instance come from a mechanical pre-concentration, is supplied and pumped through a heat exchanger. In this heat exchanger the supplied biomass is preheated to a temperature in the order of 100° Celsius, this being the temperature at which the preheated biomass enters the reactor. In the reactor the temperature is increased to more than 100° Celsius by supplying steam, while a high pressure is effected by pumps and restrictions such that the biomass in the reactor does not boil. Cell structures in the biomass which are difficult to break down are “cracked” at the high temperature and pressure, and degradable components are released more easily. In the TurboTec® process this “cracking” takes place at a pressure in the order of 2-8 bar and a temperature in the order of 120-170° Celsius. When the hydrolysed biomass leaves the reactor at this high temperature, it is guided through a heat exchanger so as to be cooled before the cooled biomass is guided to a fermenting installation. The heat extracted from the hydrolysed biomass during cooling can be used here to preheat the fresh biomass.

The known method has a number of drawbacks. It is for instance difficult to find and maintain a correct heat balance in the process. It is particularly found to be no simple matter in practice to sufficiently preheat the fresh biomass using the heat extracted from the hydrolysed biomass by making use of only a limited number of heat exchangers. The biomass hereby enters the reactor at a relatively low starting temperature inside the reactor, whereby a relatively large amount of steam has to be supplied in order to set the correct process conditions for the hydrolysis. This is detrimental to the efficiency of the method, and because the heat transfer between the hydrolysed biomass and the supplied fresh biomass is not optimal, the hydrolysed biomass is also insufficiently cooled during preheating of the fresh biomass. This necessitates extra cooling to bring the hydrolysed biomass to a temperature at which it can be further processed in a fermenting installation. And finally, the viscosity of the supplied fresh biomass is quite high so that it can be pumped through the heat exchanger(s) only with great difficulty, wherein high pressures occur in the heat exchanger(s). The high pump capacity required also reduces the efficiency.

From WO 03/043939 A2 a method and installation are known for treating biodegradable organic waste which is supplied in particulate form. This concerns a badge process in which biodegradable domestic waste, in particular vegetables, fruit and gardening waste is first seized into parts having a particle seize in the order of 6 to 50 mm. Subsequently the waste is preheated by a liquid common from a hydrolysis reactor. This preheating can be done by mixing or by contactless heat exchange. In case of mixing, the mixture of the waste and liquid is then separated, after which the solid waste is guided to a presteaming bin, where it is preheated by steam. From there the waste is guided to a the reactor for hydrolysis at a temperature up to 130-170° C. and a pressure of 300 kPa to 2,5 mPa (3-25 bar). Subsequently, the mass from the hydrolysis reactor is guided to a flash-tank, where steam is recovered for reuse in the steam bin. The hydrolysed mass is then separated in a separator into a fraction to be composted and the liquid fraction for preheating the waste supply. Eventually the liquid after mixing and separating is further treated in an anaerobic reactor for forming methane gas, treated effluent and solid material. As indicated above, this concerns a discontinuous process or badge-process.

The invention now has for its object to improve a method of the above described type such that the stated drawbacks do not occur, or at least do so to lesser extent. This is achieved according to the invention in that the supplied biomass is preheated in at least two steps, wherein in one of the steps at least a part of the supplied biomass is mixed with at least a part of the hydrolysed biomass, and wherein in another step at least a part of the supplied biomass is brought into heat-exchanging contact with a prewarming or preheating medium.

Mixing the supplied biomass with (a part of) the hydrolysed biomass results in a very direct heat transfer which cannot be achieved in a heat exchanger. Apart from possible precooling to be discussed below, the hydrolysed biomass is not processed before being mixed with the supplied biomass. By combining mixing with heat transfer through a heating medium, the supplied fresh biomass is eventually preheated to an extent sufficient to limit as far as possible the steam supply necessary in the reactor vessel. Another advantage is that the viscosity of the supplied fresh biomass is decreased after mixing such that it can be easily pumped through a heat exchanger. The pressure in the heat exchanger is hereby reduced and the necessary pump capacity is also reduced.

When the prewarming or preheating medium comprises hydrolysed biomass or has been in heat-exchanging contact with at least a part of the hydrolysed biomass, heat from the hydrolysed biomass can also be transferred to the supplied biomass in the heat-exchanging step. In this way the efficiency of the conversion is further increased.

In order to preheat the supplied fresh biomass as quickly and thoroughly as possible, at least 25 percent, more preferably at least 75 percent and most preferably substantially 100 percent of the hydrolysed biomass can be mixed with the supplied fresh biomass.

The supplied biomass can have a viscosity which is one or more orders of magnitude higher than the viscosity of the hydrolysed biomass, and which for example amounts to several thousands or ten thousands of mPa.s while the viscosity of the hydrolysed biomass amounts to several hundreds of mPa.s. However, in both cases there is a mass which is highly uniform without discrete particles.

The high viscosity of the supplied fresh biomass can be easily achieved, when prior to mixing a flocculent is added to the fresh biomass. A polyelectrolyte maybe used as flocculent.

The mixture formed during the preheating can be substantially separated/concentrated again to form preheated, fresh biomass and partially cooled, hydrolysed biomass. The hydrolysed biomass which has been sufficiently cooled by the mixing can thus be further processed properly.

During separation apart of the hydrolysed biomass can be entrained by the preheated fresh biomass. Relatively large flocks or agglomerates in the already hydrolysed biomass which have been cracked insufficiently can thus be subjected once again to a hydrolysis process. Substantially wholly hydrolysed biomass is hereby discharged to the fermentation installation, so increasing the efficiency of the fermentation compared to conventional methods.

The fresh biomass and the hydrolysed biomass can be mixed such that the fresh biomass is heated by several tens of degrees. A considerable rise in temperature of for example 20-60° C. is thus already obtained, whereby the desired entry temperature in the hydrolysis reactor in the order of 90-115° C. can be achieved with relatively little effort.

The biomass mixture can be separated by being screened. Because the fresh biomass will have a considerably higher viscosity (under identical circumstances) than the hydrolysed biomass, a highly effective separation can be achieved in simple manner by screening, for instance with a vibrating screen or a rotating screen. Other separating techniques such as filtering, centrifugation or cyclone separation can however also be envisaged.

Following the step of mixing and optional separation at least a part of the hydrolysed biomass can be fed back and mixed with the supplied fresh biomass prior to the preheating. The temperature of the supplied fresh biomass is thus already increased at the start of the process, making the biomass easier to pump and moreover making it possible to operate with smaller heat exchangers for further temperature increases.

Following the step of mixing and optional separation the hydrolysed biomass can be further cooled so as to be brought to a temperature suitable for further processing.

The hydrolysed biomass can be further cooled by being brought into heat-exchanging contact with a cooling medium. This can take place for instance in a heat exchanger.

Prior to the step of mixing, the fresh biomass can be brought into heat-exchanging contact with a preheating medium. As preheating alternative, it is also possible to envisage a situation where the biomass is further concentrated at the start and brought to the desired concentration (percentage DS) by means of adding hot water.

A single medium can be used as cooling medium for the hydrolysed biomass and as preheating medium for the fresh biomass. Via this shared medium heat can thus be recovered from the hydrolysed biomass.

Although the supplied fresh biomass will already have undergone a considerable temperature increase through being mixed with the hydrolysed biomass, it can be advantageous to bring the supplied biomass into heat-exchanging contact with the heating medium after the step of mixing, but prior to the hydrolysis. The biomass can thus be fed to the reactor at a high temperature such that relatively little steam is necessary for the hydrolysis. Because the biomass is preheated due to the mixing, it is possible to suffice with (a) relatively small heat exchanger(s) for the further heating.

The hydrolysed biomass can be pre-cooled prior to the mixing by being brought into heat-exchanging contact with a pre-cooling medium. The mixer is thus not exposed to excessive temperatures.

A single medium can be used as pre-cooling medium for the hydrolysed biomass and as heating medium for the supplied biomass. The heat from the hydrolysed biomass can thus be recovered via this shared medium.

The invention further relates to an installation for thermal digestion of pumpable biomass.

A conventional thermal digestion installation for pumpable biomass, for instance applicant's own TurboTec®, comprises means for supplying fresh biomass, means connected to the supply means for preheating the fresh biomass, a reactor connected to the preheating means for hydrolysing the preheated biomass, means connected to a discharge side of the reactor for cooling the hydrolysed biomass and means connected to the cooling means for discharging the cooled biomass.

The installation according to the present invention is now distinguished from this conventional installation in that at least the preheating means comprise at least two stages, wherein one of the stages comprises a mixing device connected to the supply means and to the discharge side of the reactor for the purpose of mixing the supplied fresh biomass and the hydrolysed biomass, and wherein another stage comprises a heat exchanger for bringing the supplied biomass into contact with a prewarming or preheating medium.

In one embodiment of the installation the separating device may be configured to separate a part of the hydrolysed biomass with the supplied fresh biomass from the rest of the hydrolysed biomass.

In a further embodiment of the installation the separating device may comprise at least one screen.

In an embodiment of the installation the part of the cooling means placed between the mixing device and the discharge means may comprise at least one heat exchanger.

In a further embodiment of the installation the at least one heat exchanger of the cooling means and the at least one heat exchanger of the preheating means may form a circuit for a shared heat-exchanging medium.

In one embodiment of the installation the at least one heat exchanger of the preheating means and the at least one pre-cooling heat exchanger may form a circuit for a shared heat-exchanging medium.

Further embodiments of the thermal digestion installation according to the invention are described in the dependent claims 12 to 20.

The invention will now be elucidated on the basis of a number of embodiments, wherein reference is made to the accompanying drawing in which corresponding components are designated with reference numerals increased in each case by 100, and in which:

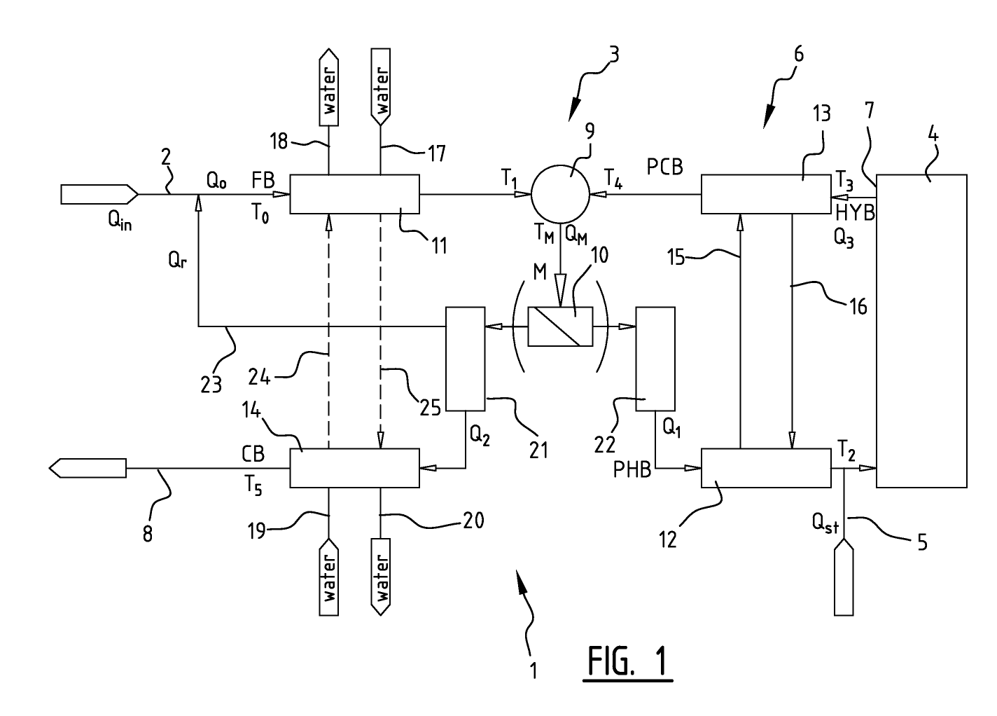

FIG. 1 is a schematic representation of an installation according to a first embodiment of the invention, wherein heat exchange between the fresh biomass and the hydrolysed biomass takes place both before and after mixing,

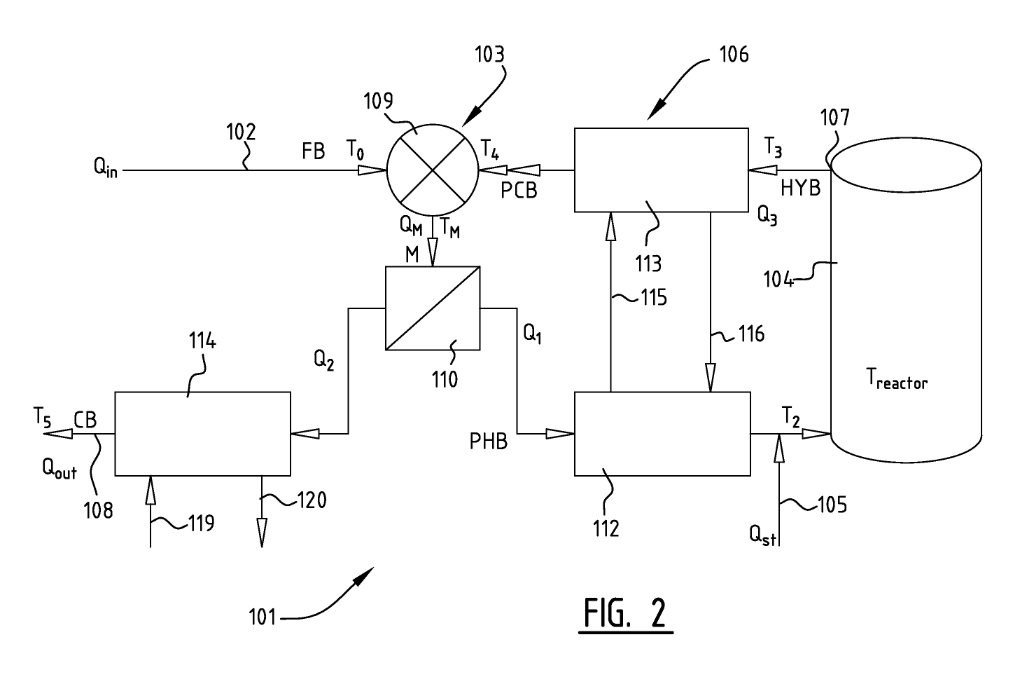

FIG. 2 is a view corresponding to FIG. 1 of an alternative embodiment, wherein the fresh supplied biomass is directly mixed with the hydrolysed biomass, and

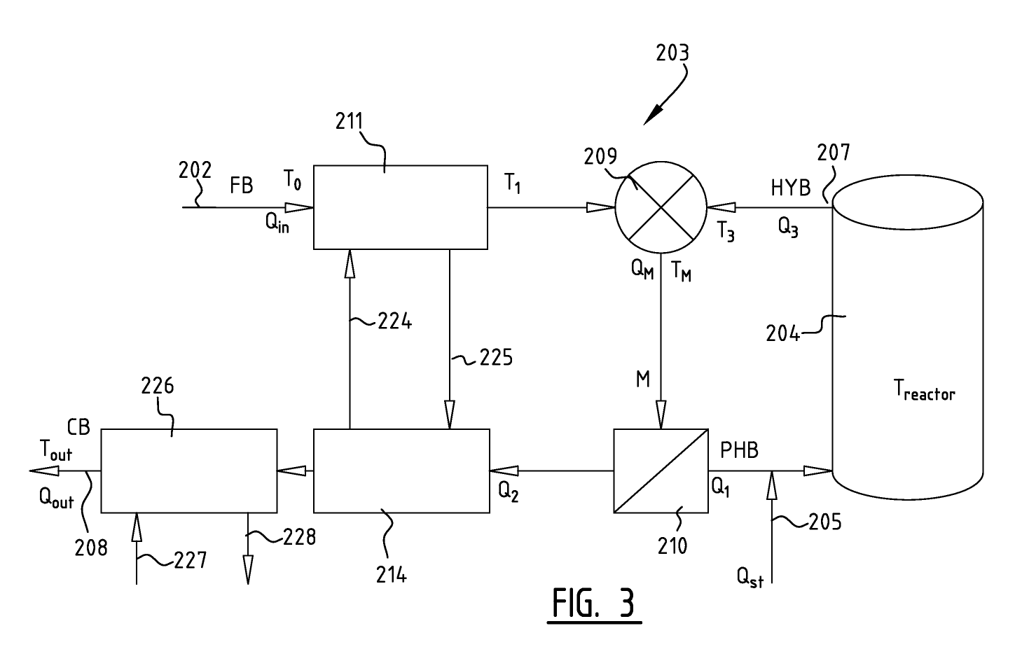

FIG. 3 is a view corresponding to FIGS. 1 and 2 of an embodiment wherein between the mixing and the hydrolysis no further heat exchange takes place between the different process flows.

An installation 1 for thermal digestion of pumpable biomass, like sewage sludge, comprises means 2 for supplying fresh biomass FB, means 3 connected to supply means 2 for preheating the fresh biomass FB and a reactor 4 connected to preheating means 3 for hydrolysing the preheated biomass PHB. Connected to reactor 4 is a steam supply 5. The installation further comprises means 6 for cooling the hydrolysed biomass HYB which are connected to a discharge side 7 of reactor 4, and means 8 for discharging the cooled biomass CB which are connected to cooling means 6.

According to the invention the installation 1 is further provided with a mixing device 9 for mixing the supplied fresh biomass FB and the hydrolysed biomass HYB which is connected on one side to supply means 2 and connected on the other to discharge side 7 of reactor 4.

The preheating means 3 and the mixing device 9 constitute a two stage or multistage system for bringing the supplied fresh biomass to a suitable entry temperature for the reactor 4. On the other hand, the cooling means 6 and the mixing device also constitute a two stage or multistage system for cooling the hydrolysed biomass.

Installation 1 according to the invention also has a device 10 for separating the biomass mixture M formed in mixing device 9. This separating device 10 can comprise one or more screens, for instance vibrating screens or rotating screens.

In the shown embodiment preheating means 11 in the form of one or more heat exchangers are placed between supply means 2 for the fresh biomass FB and mixing device 9. Means 12 are further arranged between separating device 10 and reactor 4 for further heating of the preheated biomass PHB, likewise in the form of one or more heat exchangers. In the shown embodiment a buffer 22 is also placed between separating means 10 and the further heating means 12. In combination with the mixing device 9, this means that the supplied biomass is heated in three steps before reaching the reactor 4.

Cooling means 6 also already comprise two separate stages in the shown embodiment. Placed between the discharge side of reactor 4 and mixing device 9 are pre-cooling means 13, once again in the form of one or more heat exchangers. Another part of cooling means 6 is located between separating device 10 and discharge means 8 for the cooled biomass CB and comprises one or more heat exchangers 14 which form(s) a further cooling stage. A buffer 21 is here also placed between separating means 10 and heat exchanger(s) 14 of the further cooling stage. In the shown embodiment there is further also a feedback conduit 23 which connects buffer 21 to supply means 2. Including the mixing device 9, the hydrolysed biomass is also cooled in three steps here.

In the shown embodiment the heat exchanger(s) of the further heating means 12 and the heat exchanger (s) of pre-cooling means 13 are incorporated in a circuit in which their shared heat-exchanging medium flows. Heat exchangers 12, 13 are connected for this purpose by circulation conduits 15, 16.

The heat exchanger(s) of heating means 11 form(s) part of an external circuit with a conduit 17 through which a heat-exchanging medium with relatively high temperature is supplied and a conduit 18 through which this medium is discharged once it has relinquished its heat to the supplied fresh biomass FB.

The heat exchanger(s) 14 of the further cooling means similarly form(s) part of an external circuit with a supply conduit 19 which supplies a relatively cool heat-exchanging medium and discharge conduit 20 through which the medium is discharged once it has extracted heat from the biomass CB to be discharged.

As shown with broken lines, it is however also possible to envisage the heat exchanger(s) of preheating means 11 and the heat exchanger(s) 14 of the further cooling stage being incorporated in a circuit in which a shared heat-exchanging medium again flows. Heat exchangers 11, 14 can then be connected for this purpose by circulation conduits 24, 25.

The operation of the above described thermal digestion installation 1 is now described on the basis of a numerical example.

It is assumed here is that supply means 2 supply a quantity Qᵢₙ of fresh biomass FB having a starting temperature T₀ of 10-30° Celsius. This fresh biomass FB will normally have a dry substance content (DS) of 5-15 percent. The fresh biomass FB has already been pre-screened upstream of the supply means 2, so that all particles greater than a certain seize, in this case 2 mm, have already been removed. Furthermore, a flocculent, for instance a polyelectrolyte, has been added to the pre-screened fresh biomass, so that the fresh biomass FB has a uniform, somewhat paste-like or jelly-like consistency. A mass flow Qᵣ of hydrolysed biomass from buffer 21 is mixed with the fresh biomass flow Qᵢₙ via feedback conduit 23. In heat exchanger (s) 11 the resulting mass flow Q₀ (=Qᵢₙ+Qᵣ₎ is preheated to a temperature T₁ of 30-50° Celsius. Use is made for this purpose of a heat-exchanging medium which is supplied through conduit 17 at a temperature in the order of 70-90° Celsius and which leaves the heat exchanger(s) through conduit 18 at a temperature of 10-30° Celsius. The heat-exchanging medium used for the preheating can otherwise come from a combined heat and power (CHP) unit.

The preheated fresh biomass is mixed in mixing device 9 with pre-cooled biomass PCB which has already been partially cooled in the heat exchanger (s) of pre-cooling means 13 following hydrolysis in reactor 4. The hydrolysed biomass is not further processed prior to mixing. The preheated fresh biomass and the precooled hydrolysed biomass have considerably different viscosities prior to mixing. The viscosity of the hydrolysed biomass is in the order of magnitude of 100 to several hundreds mPa.s. The viscosity of the supplied biomass on the other hand, is at least one and possibly two or more orders of magnitude greater, even after preheating. Depending on the speed with which the biomass is supplied and the dimensions of the conduits through which it is supplied, which together determine the sheer rate, on one hand, and depending on the temperature on the other hand, the viscosity of the supplied biomass can amount to several thousands or even tens of thousands or hundreds of thousands of mPa.s, even after preheating. The mixture of these biomass flows having such greatly different viscosities forms an emulsion.

In the shown embodiment the whole mass flow Q₃ of pre-cooled biomass PCB is fed from pre-cooling means 13 to mixing device 9. It is however also possible to mix only a part of the hydrolysed biomass HYB with the fresh biomass, wherein the positive effects of the invention are particularly manifest when 25 percent or more of the hydrolysed biomass HYB is admixed. It should be noted that “a part” is not intended to denote a particular fraction (for instance the liquid fraction) of the hydrolysed biomass HYB, but merely a portion of the total mass flow. The mass flow Q₃ is greater than the supplied quantity of biomass Q₁ because a part of the hydrolysed biomass HYB is recirculated in the reactor, while additionally a determined quantity of steam Qₛₜ is supplied continuously. The numerical example assumes that the pre-cooled biomass PCB still has a temperature T₄ of 90-110° Celsius, whereby the mixture M formed in mixing device 9 will eventually reach a temperature T_{M} of 60-80° Celsius. A considerable rise in the temperature of the supplied fresh biomass FB is thus achieved.

The mixture M is supplied in a quantity Q_{M} to separating device 10, where the supplied fresh biomass is again separated from the hydrolysed biomass by sieving the emulsion. Surprisingly is has been found here that it is in principle possible to in fact again completely separate the emulsion into its starting components, the very highly viscose supplied fresh biomass—practically a gel—and the very low viscosity hydrolysed biomass—practically a thin liquid. The viscosities of the partial flows leaving the separating device 10 are again very different from each other. When exiting the separating device 10 the viscosity of the preheated biomass PHB can be at least twice as high as the viscosity of the hydrolysed biomass.

In the illustrated embodiment separating device 10 is configured here such that with the fresh biomass a part of the biomass which comes from reactor 4 but which is not yet fully hydrolysed is also separated from the fully hydrolysed biomass. The biomass which is not fully hydrolysed will comprise larger flocks or agglomerates than the fully hydrolysed biomass, while the flocks or agglomerates of the fresh biomass FB will be even larger. In the shown embodiment a quantity Q₁ of the mixture M in the form of preheated fresh biomass—having therein a small fraction of incompletely hydrolysed biomass—is in this way separated from a mass flow Q₂ consisting substantially of fully hydrolysed biomass. This latter flow Q₂ is guided via buffer 21 to heat exchanger(s) 14 of the further cooling means and there cooled to a temperature T₅ in the order of 40-60° Celsius. Use is made here of cooling water supplied through conduit 19 at a temperature of for instance 20° Celsius.

The flow of preheated biomass PHB and the fraction of incompletely hydrolysed biomass entrained therein is guided further via buffer 22 to heat exchanger(s) 12 so as to be further heated there. Because this/these heat exchanger(s) 12 is/are incorporated in a circuit with the heat exchanger(s) of pre-cooling means 13, the rise in the temperature of the preheated biomass PHB is linked to the fall in the temperature of the hydrolysed biomass HYB in heat exchanger(s) 13. In the shown embodiment the hydrolysed biomass HYB leaves discharge side 7 of reactor 4 at a temperature T₃ in the order of 140° Celsius and is cooled in heat exchanger (s) 13 to T₄ in the order of 90-110° Celsius. Because the flow rate Q₃ through heat exchanger(s) 13 is slightly higher than the flow rate Q₁ through heat exchanger(s) 12—the difference being formed by the continuously supplied quantity of steam Qₛₜ (Q₃=Qᵢ+Qₛₜ)—the increase in the temperature of the preheated biomass PHB is therefore slightly greater than the decrease in the temperature of the hydrolysed biomass HYB.

In this embodiment the fully heated biomass finally enters reactor 4 at a temperature T₂ of 90-120° Celsius, where a quantity Qₛₜ of steam is admixed. The biomass is heated in reactor 4 by this admixture of steam to a temperature T_{reactor} of 110-170° Celsius, in this example about 140° Celsius. At these temperatures a pressure of 2-8 bar, in the illustrated embodiment a pressure in the order of 4 bar is maintained in reactor 4. As a result of the increased temperature and pressure the cell walls of the bacteria in the biomass are broken open so that the degradable component of the biomass enclosed therein is released. More biogas can hereby be produced in a later fermenting step, while the decomposition of the dry substance is also improved.

In an alternative embodiment of the thermal digestion installation 101 (FIG. 2) there are no provisions for preheating the supplied fresh biomass FB before it reaches mixing device 109. Because the fresh biomass FB is mixed at ambient temperature with the hydrolysed biomass which has already been subjected to a pre-cooling step in heat exchanger 113, the resulting temperature of the mixture M presented to separating device 110 is also lower than in the embodiment of FIG. 1. The difference in viscosity between the fresh biomass FB and the hydrolysed biomass that is mixed therewith is also greater in this embodiment than in the embodiment of FIG. 1. Due to the lower starting temperature, the viscosity of the supplied biomass may be up to 50 percent higher than that of the preheated biomass of FIG. 1.

With a similar supply of fresh biomass as in the embodiment of FIG. 1 the temperature of the mixture M will for instance be 10° C. lower, whereby the preheated biomass PHB will also enter reactor 104 at a temperature about 10° lower after the period in heat exchanger(s) 112 of the further heating means. A greater quantity of steam is hereby necessary in order to still achieve the desired pressures and temperatures in reactor 104. On the other hand there is a substantial simplification of the installation, which is the result of dispensing with the heat exchanger(s) for the preheating of the fresh biomass FB. It should be noted that the additional steam consumption may be reduced by providing the heat exchanger 112, 113 with a greater capacity than the heat exchangers 12, 13 of the embodiment of FIG. 1.

In yet another embodiment of installation 201 (FIG. 3) the supplied fresh biomass FB is preheated before being fed to mixing device 209, although no further heating takes place in a heat exchanger downstream of separating device 210. The temperature is brought to the desired value using external heat input 205, for instance steam, before the biomass is fed to reactor 204. A greater temperature increase then has to be brought about in heat exchanger(s) 211 of the preheating means than in heat exchanger(s) 11 of the first embodiment, for instance in the order of 50° Celsius. In this embodiment heat exchanger(s) 211 of the preheating means and heat exchanger(s) 214 of the further cooling means are incorporated in a circuit for a shared heat-exchanging medium. Part of the heat present in the hydrolysed biomass is hereby used after mixing and separating to preheat the supplied fresh biomass FB. Because the hydrolysed biomass still has a relatively high temperature, in the order of more than 60° Celsius, after leaving heat exchanger(s) 214, installation 201 is also provided in this embodiment with an additional cooling stage 226 in which the biomass is further cooled by means of cooling water in an external circuit 227, 228.

The invention thus makes it possible, by making use of relatively small heat exchangers, to have a flow of supplied fresh biomass nevertheless undergo a relatively great temperature increase.

Although the invention has been elucidated above on the basis of a number of embodiments, it will be apparent that it is not limited thereto but can be varied in many ways. In the embodiments of FIGS. 2 and 3 a feedback conduit can thus also be provided to add a part of the biomass, after mixing—and/or separation—to the flow of fresh biomass. Situations can further be envisaged in which it is possible to dispense with a separation after the mixing. Instead of a continuous separation into part-flows, the whole mixed flow could for instance be guided alternately to the reactor or to the discharge means. Other options can also be envisaged for heating of the reactor than the supply of steam, for instance by making use of a heating spiral in which thermal oil circulates.

The scope of the invention is therefore defined solely by the following claims.

1. A method for thermal digestion of pumpable biomass, comprising the steps of:
supplying fresh biomass,
preheating the supplied fresh biomass,
hydrolysing the preheated biomass,
cooling the hydrolysed biomass, and
discharging the cooled biomass,
wherein the supplied biomass is preheated in at least two steps, wherein in one of the steps at least a part of the supplied biomass is mixed with at least a part of the hydrolysed biomass, and wherein in another step at least a part of the supplied biomass is brought into heat-exchanging contact with a prewarming or preheating medium.

2. The method as claimed in claim 1, wherein the prewarming medium or preheating medium comprises hydrolysed biomass or has been in heat-exchanging contact with at least a part of the hydrolysed biomass.

3. The method as claimed in claim 1, wherein at least 25 percent, more preferably at least 75 percent and most preferably substantially 100 percent of the hydrolysed biomass is mixed with the supplied fresh biomass.

4. The method as claimed in claim 1, wherein the supplied fresh biomass has a viscosity which is one or more orders of magnitude higher than the viscosity of the hydrolysed biomass.

5. The method as claimed in claim 1, wherein the mixture formed during the preheating is substantially separated again into preheated, fresh biomass and partially cooled, hydrolysed biomass.

6. The method as claimed in claim 1, wherein the fresh biomass and the hydrolysed biomass are mixed such that the fresh biomass is heated by several tens of degrees.

7. The method as claimed in claim 1, wherein following the step of mixing and optional separation at least a part of the hydrolysed biomass is fed back and mixed with the supplied fresh biomass prior to the preheating.

8. The method as claimed in claim 1, wherein following the step of mixing and optional separation the hydrolysed biomass is further cooled.

9. The method as claimed in claim 1, wherein prior to the step of mixing the fresh biomass is brought into heat-exchanging contact with the preheating medium.

10. The method as claimed in claim 1, wherein following the step of mixing but prior to the hydrolysis the supplied biomass is brought into heat-exchanging contact with the heating medium.

11. The method as claimed in claim 1, wherein the hydrolysed biomass is pre-cooled prior to the step of mixing by being brought into heat-exchanging contact with a pre-cooling medium.

12. An installation for thermal digestion of pumpable biomass, comprising:
means for supplying fresh biomass,
means connected to the supply means for preheating the fresh biomass,
a reactor connected to the preheating means for hydrolysing the preheated biomass,
means connected to a discharge side of the reactor for cooling the hydrolysed biomass, and
means connected to the cooling means for discharging the cooled biomass,
wherein at least the preheating means comprise at least two stages, wherein one of the stages comprises a mixing device connected to the supply means and to the discharge side of the reactor for the purpose of mixing the supplied fresh biomass and the hydrolysed biomass, and wherein another stage comprises a heat exchanger for bringing the supplied biomass into contact with a prewarming or preheating medium.

13. The installation as claimed in claim 12, wherein the heat exchanger is connected to the discharge side of the reactor and the prewarming or preheating medium comprises hydrolysed biomass or has been in heat-exchanging contact with at least a part of the hydrolysed biomass.

14. The installation as claimed in claim 12, wherein the mixing device is configured to mix at least 25 percent, more preferably at least 75 percent and most preferably substantially 100 percent of the hydrolysed biomass with the supplied fresh biomass.

15. The installation as claimed in claim 12, further comprising a separating device connected to the mixing device for at least partially separating the biomass mixture formed there.

16. The installation as claimed in claim 12, further comprising feedback means placed between the mixing means and the supply means for feeding back and mixing at least a part of the hydrolysed biomass with the supplied fresh biomass prior to the preheating.

17. The installation as claimed in claim 12, wherein at least a part of the cooling means is situated between the mixing device and the discharge means.

18. The installation as claimed in claim 12, wherein the heat exchanger for bringing the fresh biomass into contact with a prewarming medium is placed between the supply means and the mixing device.

19. The installation as claimed in claim 12, wherein the heat exchanger for bringing the supplied biomass into contact with the preheating medium is placed between the mixing device and the reactor.

20. The installation as claimed in claim 12, further comprising at least one heat exchanger placed between the discharge side of the reactor and the mixing device for pre-cooling of the hydrolysed biomass.
